(19) United States
(12) Patent Application Publication
(10) Pub. No.: US 2025/0229303 A1
(43) Pub. Date: Jul. 17, 2025

(54) Sealing Tool Cleaning Device and Sealing Tool Cleaning Method Using the Same

(71) Applicant: LG Energy Solution, Ltd., Seoul (KR)

(72) Inventors: Dae Hyung Kang, Daejeon (KR); Hyun Soo Jung, Daejeon (KR)

(73) Assignee: LG Energy Solution, Ltd., Seoul (KR)

(21) Appl. No.: 18/852,771

(22) PCT Filed: Nov. 21, 2023
(86) PCT No.: PCT/KR2023/018736

§ 371 Date: Sep. 30, 2024

(30) Foreign Application Priority Data
Nov. 24, 2022 (KR) 10-2022-0159327

(51) Int. Cl. B08B 7/00; B29C 65/00; B29L 31/34

(52) U.S. Cl. CPC B08B 7/0042; B29C 66/8762; B29L 2031/3468

(57) ABSTRACT

The sealing tool cleaning device according to one example includes a laser generation part generating a carbon dioxide laser; a cleaning head part provided to enter a separation space between the pair of sealing tools, and including a head case having first and second openings opened toward the pair of sealing tools, respectively, and a head mirror part rotatably installed within the head case and provided to reflect the carbon dioxide laser toward the first opening or the second opening; and a laser transmission part provided to transmit the carbon dioxide laser generated by the laser generation part to the cleaning head part.

### CROSS-REFERENCE TO RELATED APPLICATIONS

The present application is a national phase entry under 35 U.S.C. § 371 of International Application No. PCT/KR2023/018736, filed Nov. 21, 2023, published in Korean, which claims priority from Korean Patent Application 10-2022-0159327 filed Nov. 24, 2022, all of which are incorporated herein by reference in its entirety.

### FIELD OF THE INVENTION

The present invention relates to a sealing tool cleaning device and a sealing tool cleaning method using the same, which relates to, specifically, a sealing tool cleaning device capable of removing foreign substances present in a sealing tool using a carbon dioxide laser, and a sealing tool cleaning method using the same.

### BACKGROUND OF THE INVENTION

Secondary batteries refer to batteries that can be reused repeatedly through charging and discharging. Recently, the secondary batteries have been widely used in advanced electronic devices such as smartphones, laptop computers, and electric vehicles.

Particularly, lithium secondary batteries have a high energy density per unit weight and are capable of fast charging when compared to other secondary batteries such as existing lead storage batteries, nickel-cadmium batteries, nickel-hydrogen batteries, and nickel-zinc batteries, so that they have recently been actively used in various fields.

FIG. 1 is a diagram schematically showing a pouch-type battery cell.

Referring to FIG. 1, a pouch-type battery cell (1) of a secondary battery comprises an electrode assembly (2), a pouch case (3), a positive electrode tab (4), and a negative electrode tab (5). In the pouch-type battery cell (1), the electrode assembly (2) is stored in the pouch case (3), and the positive electrode tab (4) and the negative electrode tab (5) protrude outside the pouch case (3) in a state where each is electrically connected to the electrode assembly (2).

The pouch case (3) is sealed, as heat and pressure are applied to the edge of the pouch case (3) in a state where the electrode assembly (2) is stored by a pair of sealing tools (10, 20, see FIG. 3).

The pair of sealing tools (10, 20, see FIG. 7) are made of a metal material, and the unused sealing tool is in a state without surface damage.

However, as the sealing process of the pouch case (3) is repeated, the sealing tool becomes contaminated by foreign substances falling out of the pouch case (3). The foreign substance is a substance falling out of the pouch case (3) during a process that the pair of sealing tools seals the pouch case (3). The foreign substance is the material of the pouch case (3).

At this time, if the pouch case (3) is sealed with the sealing tools having foreign substances, fine wrinkles or deep wrinkles may occur in the pouch case (3). To prevent product defects in the pouch case (3), foreign substances in the pair of sealing tools must be removed.

Conventionally, foreign substances present on the surface of the sealing tool are manually scraped off using a scraper formed by the same material as that of the sealing tool. However, there are cases where the surface of the sealing tool is worn by the scraper, and as the work of removing foreign substances from the sealing tool is performed manually, there is a problem that cleaning deviation of the sealing tool occurs depending on the operator's skill level.

### BRIEF SUMMARY OF THE INVENTION

The present invention is intended to provide a sealing tool cleaning device which enters a space between a pair of sealing tools disposed to be spaced apart up and down, and is for removing foreign substances present in the sealing tools by irradiating each sealing tool with a carbon dioxide laser, and a sealing tool cleaning method using the same.

In addition, the present invention is intended to provide a sealing tool cleaning device capable of removing only foreign substances present in the sealing tools without damaging the sealing tools by using a carbon dioxide laser with a wavelength having low reactivity with a metal, and a sealing tool cleaning method using the same.

To solve the above problem, a sealing tool cleaning device related to one example of the present invention is a sealing tool cleaning device for cleaning a pair of sealing tools sealing a pouch case for a secondary battery, which comprises a laser generation part generating a carbon dioxide laser; a cleaning head part provided to enter a separation space between the pair of sealing tools, and including a head case having first and second openings opened toward the pair of sealing tools, respectively, and a head mirror part rotatably installed within the head case and provided to reflect the carbon dioxide laser toward the first opening or the second opening; and a laser transmission part provided to transmit the carbon dioxide laser generated by the laser generation part to the cleaning head part.

Also, the cleaning head part may be connected to the laser transmission part, and comprise a lens for transmitting the carbon dioxide laser transmitted from the laser transmission part to the head mirror part, and a lens position adjusting part provided to adjust the position of the lens within the head case.

In addition, the first and second openings may extend along the longitudinal direction of the facing sealing tools, respectively, and the lens position adjusting part may be provided to move the lens along the longitudinal direction of the sealing tools within the head case. The lens position adjusting part may guide the movement of the lens, and may comprise a guide rail provided in the head case and a lens driving part for providing driving force for moving the lens on the guide rail, where the lens driving part may comprise a motor capable of rotating in the forward direction or backward direction.

Furthermore, the laser transmission part may comprise a transmission pipe part through which the carbon dioxide laser is transmitted, and one or more transmission mirror parts for adjusting the transmission direction of the carbon dioxide laser within the transmission pipe part.

Also, the transmission pipe part may comprise a plurality of transmission pipes disposed sequentially along the traveling direction of the carbon dioxide laser and at least one connection pipe part connecting the two adjacent transmission pipes, and having the transmission mirror part disposed therein.

In addition, the at least one connection pipe part may be provided so that based on one of the two adjacent transmission pipes, the other transmission pipe is rotatably connected. The transmission pipe part may have a joint structure based on at least one connection pipe part, and accordingly, when the position of the lens is adjusted by the lens position adjusting part, an angle and spacing between two adjacent transmission pipes within the transmission pipe part, and the like may be changed according to the position of the lens in the head case.

Furthermore, the sealing tool cleaning device may comprise a head position adjusting part coupled to the cleaning head part and adjusting the position of the head case so that the cleaning head part enters the separation space between the pair of sealing tools.

Also, the sealing tool cleaning device may comprise a control part for controlling the laser generation part and the cleaning head part. The control part is provided to control the head position adjusting part.

In addition, the control part may be provided to enter the cleaning head part into the separation space between the pair of sealing tools upon a cleaning mode of the pair of sealing tools. At this time, the control part may control the head position adjusting part to move the head case of the cleaning head part.

Furthermore, upon cleaning an upper sealing tool of the pair of sealing tools, the control part may adjust the reflection direction of the head mirror part to reflect the carbon dioxide laser to the first opening facing the upper sealing tool, and upon cleaning a lower sealing tool, the control part may adjust the reflection direction of the head mirror part to reflect the carbon dioxide laser to the second opening facing the head mirror. That is, when the cleaning of the upper sealing tool is completed, the cleaning of the lower sealing tool may be performed by adjusting the reflection direction of the head mirror part from the first opening side to the second opening side.

In addition, the control part may be provided to move the lens along the longitudinal direction of the upper sealing tool within the head case upon cleaning the upper sealing tool, and may be provided to move the lens along the longitudinal direction of the lower sealing tool within the head case upon cleaning the lower sealing tool. In such a structure, upon cleaning the upper sealing tool, the carbon dioxide laser is continuously irradiated along the longitudinal direction of the upper sealing tool, thereby making continuous cleaning possible. Furthermore, when the upper sealing tool cleaning is completed and the lower sealing tool is cleaned, the carbon dioxide laser is continuously irradiated along the longitudinal direction of the lower sealing tool, thereby making continuous cleaning possible.

When the head case is positioned in the separation space between the pair of sealing tools upon cleaning the upper sealing tool, the control part may adjust the reflection direction of the head mirror part so that the head mirror part reflects the carbon dioxide laser toward the first opening, and may operate the lens position adjusting part to move the lens along the longitudinal direction of the upper sealing tool.

Also, when the head case is positioned in the separation space between the pair of sealing tools upon cleaning the lower sealing tool, the control part may adjust the reflection direction of the head mirror part so that the head mirror part reflects the carbon dioxide laser toward the second opening, and may operate the lens position adjusting part to move the lens along the longitudinal direction of the lower sealing tool.

The head mirror part may comprise a head mirror disposed between the first and second openings and extending along the longitudinal direction of the sealing tool, and a head mirror driving part rotating the head mirror at a predetermined angle to adjust the reflection direction of the head mirror. The head mirror driving part may comprise a motor capable of rotating in the forward direction or backward direction.

Also, the cleaning head part may comprise a smoke intake part provided to inhale smoke generated when the sealing tool is irradiated with the carbon dioxide laser.

In addition, the control part is provided to control operations of the head mirror part, lens position adjusting part, transmission mirror part, laser generation part, and head position adjusting part.

Furthermore, the sealing tool cleaning method according to one example of the present invention is a sealing tool cleaning method using the sealing tool cleaning device, which may comprise a step (a) of mounting mask jigs on the pair of sealing tools, respectively, a step (b) of entering the cleaning head part into the separation space between the pair of sealing tools, and a step (c) of adjusting the head mirror part to reflect the carbon dioxide laser toward the first opening or the second opening of the head case.

Also, the cleaning head part may be connected to the laser transmission part, and comprise a lens for transmitting the carbon dioxide laser transmitted from the laser transmission part to the head mirror part, and a lens position adjusting part provided to adjust the position of the lens within the head case.

In addition, the sealing tool cleaning method may comprise a step of adjusting the reflection direction of the head mirror part to reflect the carbon dioxide laser toward the first opening upon cleaning the upper sealing tool of the pair of sealing tools, and operating the lens position adjusting part to move the lens along the longitudinal direction of the upper sealing tool, and a step of adjusting the reflection direction of the head mirror part to reflect the carbon dioxide laser toward the second opening upon cleaning the lower sealing tool of the pair of sealing tools, and operating the lens position adjusting part to move the lens along the longitudinal direction of the lower sealing tool.

As discussed above, the sealing tool cleaning device related to at least one example of the present invention, and the sealing tool cleaning method using the same have the following effects.

By using a carbon dioxide laser with a wavelength having low reactivity with metal, it is possible to remove only foreign substances present in the sealing tools, and by removing foreign substances from the sealing tools in a non-contact manner using a carbon dioxide laser, it is possible to prevent damage to the sealing tools.

Therefore, the present invention can increase the service life of the sealing tool, thereby reducing maintenance costs of equipment.

Also, by adjusting the reflection direction of the carbon dioxide laser to the upper sealing tool or the lower sealing tool through the angle adjustment of the head mirror, it is possible to continuously perform the cleaning of the lower sealing tool after completing the cleaning of the upper sealing tool, and accordingly, it is possible to improve the cleaning efficiency of the pair of sealing tools.

In addition, it is possible to increase the operating time of the sealing device in the pouch case for a secondary battery, and it is possible to improve the productivity of the pouch- type battery cell.

### BRIEF DESCRIPTION OF THE DRAWINGS

FIG. 1 is a diagram schematically showing a pouch-type battery cell.

FIG. 2 is a configuration diagram of a sealing tool cleaning device according to one example of the present invention.

FIG. 3 is a perspective diagram of a sealing tool cleaning device according to one example of the present invention.

FIG. 4 is a diagram of a sealing tool cleaning device according to one example of the present invention as viewed from the top.

FIG. 5 is a schematic diagram showing main components of a cleaning head part.

FIG. 6 is a diagram showing a state where a cleaning head part enters a separation space between a pair of sealing tools.

FIG. 7 is a diagram of a cleaning head part as viewed from the top.

FIG. 8 is a diagram for explaining a movement path of a carbon dioxide laser moving a laser transmission part.

FIG. 9 is a diagram for explaining a movement path of a carbon dioxide laser upon cleaning a upper sealing tool.

FIG. 10 is a diagram for explaining a movement path of a carbon dioxide laser upon cleaning a lower sealing tool.

FIG. 11 is a diagram for explaining a process that a carbon dioxide laser removes foreign substances.

FIG. 12 is a schematic diagram for explaining one operating state of a laser generation part.

### DETAILED DESCRIPTION

Hereinafter, a sealing tool cleaning device according to one example of the present invention, and a sealing tool cleaning method using the same will be described in detail with reference to the drawings.

In addition, regardless of the reference numerals, the same or corresponding components are given by the same or similar reference numerals, duplicate descriptions thereof will be omitted, and for convenience of explanation, the size and shape of each component member as shown can be exaggerated or reduced.

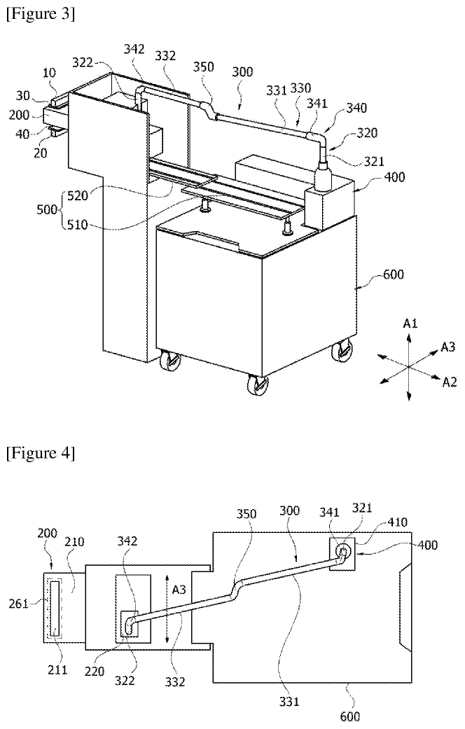

FIG. 2 is a configuration diagram of a sealing tool cleaning device (100) according to one example of the present invention, FIG. 3 is a perspective diagram of a sealing tool cleaning device according to one example of the present invention, and FIG. 4 is a diagram of a sealing tool cleaning device according to one example of the present invention as viewed from the top.

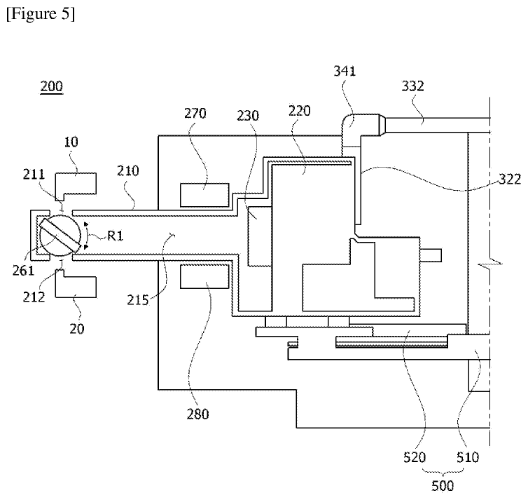

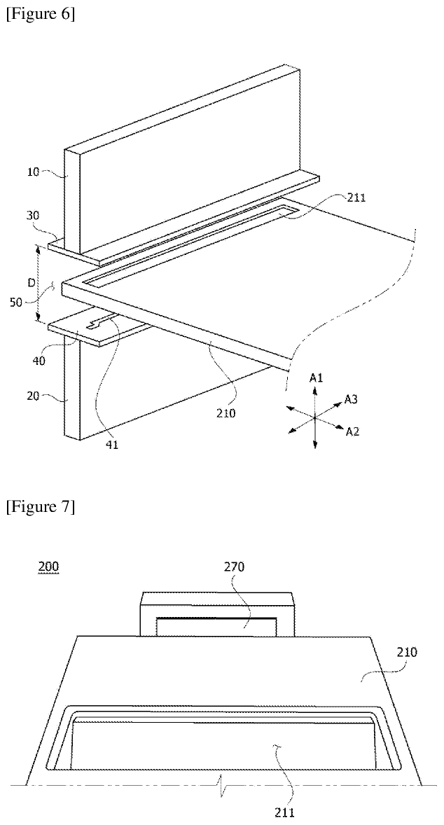

In addition, FIG. 5 is a schematic diagram showing main components of a cleaning head part, and FIG. 6 is a diagram showing a state where a cleaning head part enters a separation space between a pair of sealing tools.

The sealing tool cleaning device (100) according to one example of the present invention is a cleaning device removing foreign substances present in a pair of sealing tools (10, 20) using a carbon dioxide laser (L).

Referring to FIGS. 2 to 6, the sealing tool cleaning device (100) comprises a laser generation part (400) generating a carbon dioxide laser (L). Also, the sealing tool cleaning device (100) comprises a cleaning head part (200) provided to enter a separation space (50) between the pair of sealing tools (10, 20), and including a head case (210) having first and second openings (211, 212) opened toward the pair of sealing tools (10, 20), respectively, and a head mirror part (260) rotatably installed within the head case (210) and provided to reflect the carbon dioxide laser toward the first opening (211) or the second opening (212). In addition, the sealing tool cleaning device (100) comprises a laser transmission part (300) provided to transmit the carbon dioxide laser generated by the laser generation part (400) to the cleaning head part (200).

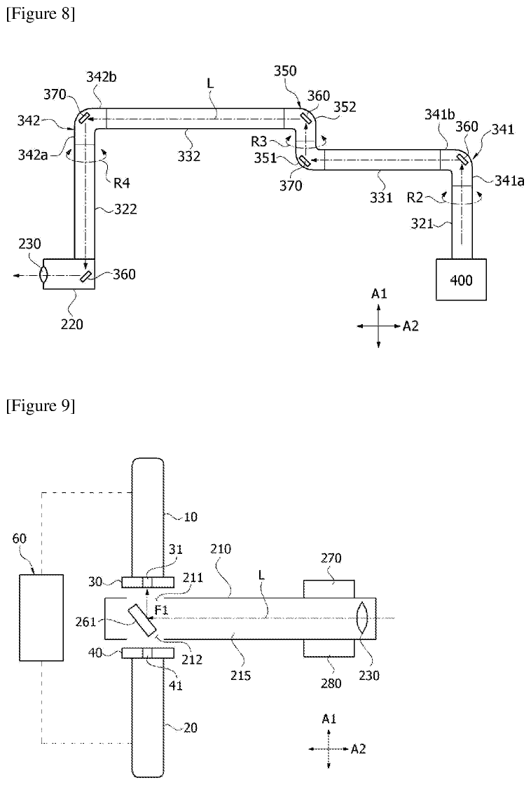

FIG. 7 is a diagram of a cleaning head part as viewed from the top, and FIG. 8 is a diagram for explaining a movement path of a carbon dioxide laser moving a laser transmission part.

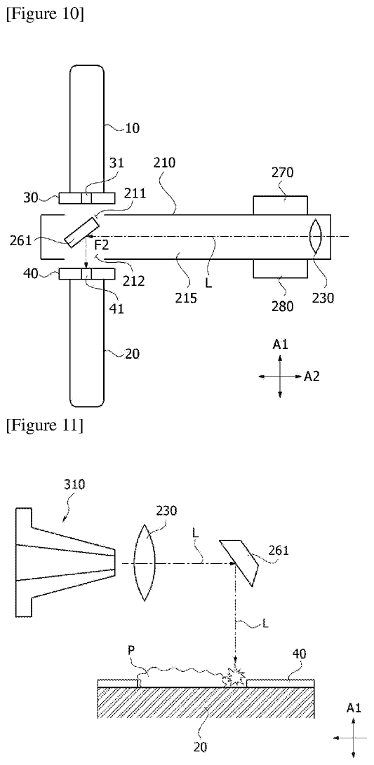

Also, FIG. 9 is a diagram for explaining a movement path of a carbon dioxide laser upon cleaning a upper sealing tool, and FIG. 10 is a diagram for explaining a movement path of a carbon dioxide laser upon cleaning a lower sealing tool.

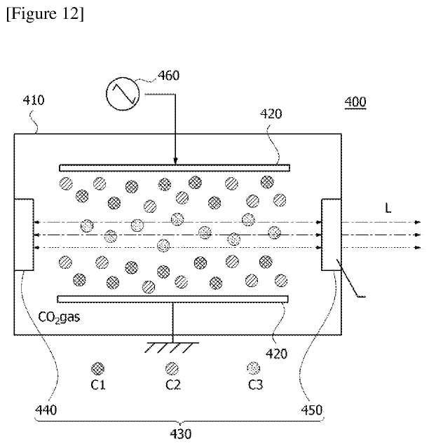

In addition, FIG. 11 is a diagram for explaining a process that a carbon dioxide laser removes foreign substances, and FIG. 12 is a schematic diagram for explaining one operating state of a laser generation part.

The sealing tool cleaning device (100) may comprise a cleaning head part (200), a laser transmission part (300), a laser generation part (400), a head position adjusting part (500), a main body part (600), and a control part (700).

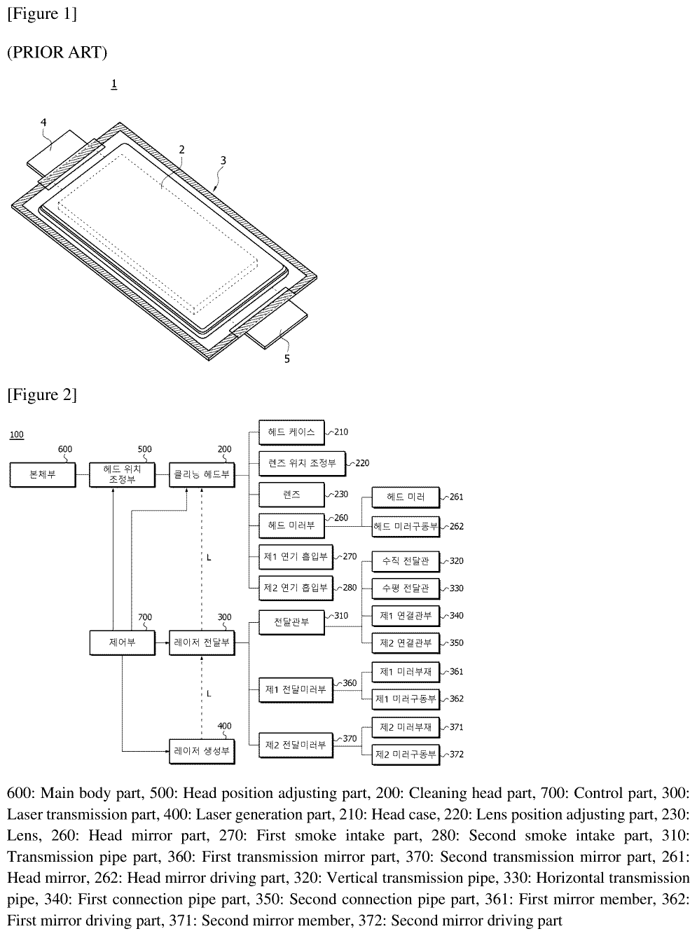

The pair of sealing tools (10, 20) are disposed to be spaced apart up and down along a first axial direction (A1) pressurizing the pouch case (3, see FIG. 1). In this document, for convenience of explanation, the pair of sealing tools (10, 20) are referred to as an upper sealing tool (10) and a lower sealing tool (20) separately.

Also, in this document, when the cleaning head part (200) enters the separation space between the pair of sealing tools, the first opening (211) of the head case (210) is an opening facing the upper sealing tool (10), which may be referred to as an upper opening, and the second opening (212) is an opening facing the lower sealing tool (20), which may be referred to as a lower opening.

In addition, the space where the upper sealing tool (10) and the lower sealing tool (20) are spaced apart by a predetermined distance (D) is referred to as a “separation space (50).” The upper sealing tool (10) and the lower sealing tool (20) may have a separation distance (D, see FIG. 6) of 10 cm or so. After the sealing process of the pouch case (3) is completed, the separation space (50) may be provided in a state where the upper sealing tool (10) and the lower sealing tool (20) are separated from the pouch case (3).

Furthermore, the sealing device (60) provided to perform the sealing of the pouch case (3) comprises a pair of sealing tools (10, 20), where the sealing tool cleaning device (100) may also be configured separately from the sealing device (60). At this time, when the sealing process (also referred to as a ‘sealing mode’) through the sealing device (60) is completed, the cleaning head part (200) of the sealing tool cleaning device (100) may be provided so that it enters the separation space between the pair of sealing tools, and then is separated from the sealing device (60) again after completing the cleaning process (also referred to as a ‘cleaning mode’) of the respective sealing tools (10, 20).

Meanwhile, the upper sealing tool (10) and the lower sealing tool (20) have a narrow separation distance (D) of 10 cm, so that conventionally, an operator scraped off foreign substances from the surfaces of the sealing tools (10, 20) using a scraper or cutter made of the same material as that of the sealing tools (10, 20), and accordingly, wear occurred on the surfaces of the sealing tools (10, 20).

To solve such a problem, the cleaning head part (200) is inserted into the separation space (50, see FIG. 6) of the upper sealing tool (10) and the lower scaling tool (20), and removes foreign substances present in the sealing tools (10, 20) in a non-contact manner using the carbon dioxide laser (L), whereby the sealing tool cleaning device (100) can clean the sealing tools (10, 20) without damaging the scaling tools (10, 20).

Referring to FIGS. 3 to 6, in this document, the first axial direction (A1) means the direction where the pair of sealing tools (10, 20) approaches or moves away in the sealing mode, and the second axial direction (A2) means the direction where the cleaning head part (200) enters the separation space (50) between the pair of sealing tools (10, 20), and the first axial direction (A1) and the second axial direction (A2) are directions to be orthogonal. In addition, the third axial direction (A3) is a direction orthogonal to the first axial direction (A1) and the second axial direction (A2), respectively, which means the longitudinal direction of the sealing tools (10, 20) or the direction where the first and second openings (211, 212) are extended.

Meanwhile, upon cleaning the upper sealing tool (10) and lower sealing tool (20) in the cleaning mode, mask jigs (30, 40) may be mounted on the upper sealing tool (10) and lower sealing tool (20), respectively. The mask jigs (30, 40) have jig openings (31, 41) having shapes corresponding to the pressurization surfaces of the sealing tools (10, 20). In a state where the mask jigs (30, 40) are mounted on the sealing tools (10, 20), the pressurization surfaces of the sealing tools (10, 20) are exposed to the separation space (50) through the jig openings (31, 41). The pressurization surface refers to the surface contacting the pouch case (3) during the sealing process of the pouch case (3), and is a region that needs to be cleaned by the carbon dioxide laser (L) after performing the sealing process.

The mask jigs (30, 40) are portions other than the sealing tools (10, 20), which perform a function to prevent the carbon dioxide laser (L) from being irradiated.

The sealing tool cleaning device (100) may comprise a main body part (600) on which a cleaning head part (200), a laser transmission part (300), a laser generation part (400), and a head position adjusting part (500) provided to enter the cleaning head part (200) into the separation space between the pair of sealing tools are each mounted. The cleaning head part (200) may be movably provided in the main body part (600).

Also, the sealing tool cleaning device (100) may comprise a control part (700) for controlling the laser generation part (400) and the cleaning head part (200).

The operation of the cleaning head part (200) is controlled by the control part (700).

The cleaning head part (200) enters the separation space (50) between the pair of sealing tools (10, 20) to irradiate any one sealing tool (10, 20) of the pair of sealing tools (10, 20) with the carbon dioxide laser (L).

Referring to FIGS. 3 and 6, the cleaning head part (200) is provided to enter the separation space (50) between the pair of sealing tools (10, 20) in a second axial direction (A2) perpendicular to the first axial direction (A1) in which the pair of sealing tools (10, 20) pressurizes the pouch case. In addition, the cleaning head part (200) may be provided to transmit the carbon dioxide laser (L) along the first axial direction (A1) to any one sealing tool (10, 20) of the pair of sealing tools (10, 20).

The cleaning head part (200) may comprise a head case (210), a head mirror part (260), a lens (230) which is connected to the laser transmission part (300) and for transmitting the carbon dioxide laser transmitted from the laser transmission part (300) to the head mirror part (260), and a lens position adjusting part (220) provided to adjust the position of the lens (20) within the head case (210). In addition, the cleaning head part (200) may comprise one or more smoke intake parts (270, 280) provided to inhale smoke generated when the sealing tools (10, 20) are irradiated with the carbon dioxide laser.

Referring to FIGS. 4 and 5, the head case (210) may have an upper opening (211), a lower opening (212), and a passage (215). The upper opening (211) and the lower opening (212) are openings through which the carbon dioxide laser (L) passes.

The upper opening (211) is an opening that penetrates the upper surface of the head case (210) in the first axial direction (A1), but extends along the third axial direction (A3). Also, the lower opening (212) is an opening that penetrates the lower surface of the head case (210) in the first axial direction (A1), but extends in the third axial direction (A3).

In addition, the upper and lower openings (211, 212) may extend along the longitudinal direction (third axial direction) of the facing sealing tools (10, 20), respectively, and the lens position adjusting part (220) may be provided to move the lens (230) along the longitudinal direction of the sealing tool, that is, the third axial direction (A3) in the head case (210).

When the head case (210) is placed in a cleaning position, the upper opening (211) is disposed to face the upper sealing tool (10), and the lower opening (212) is disposed to face the lower sealing tool (20). Here, the cleaning position is a position where the upper opening (211) and the lower opening (212) are disposed approximately coaxially with the pair of sealing tools (10, 20) in the first axial direction (A1).

Referring to FIGS. 5 and 6, the head case (210) has a structure capable of entering the separation space (50) between the upper sealing tool (10) and the lower sealing tool (20) in the second axial direction (A2) perpendicular to the first axial direction (A1).

Referring to FIGS. 3 and 5, the head case (210) is coupled to the head position adjusting part (500), and its position is adjusted by the head position adjusting part (500).

The head position adjusting part (500) adjusts the position of the head case (210) so that the head case (210) enters the separation space (50) between the pair of sealing tools (10, 20) in the second axial direction (A2).

Referring to FIGS. 3 and 5, the head position adjusting part (500) may comprise a fixed rail (510) and a moving block (520). The fixed rail (510) may be coupled to the main body part (600). The moving block (520) may be coupled to the fixed rail (510) to enable reciprocating movement back and forth. The head case (210) may be coupled to the moving block (520).

The moving block (520) may move the head case (210) from a standby position to the cleaning position while moving back and forth in the second axial direction (A2) along the fixed rail (510). The head position adjusting part (500) stops the forward movement of the moving block (520) when the head case (210) is positioned in the cleaning position. In addition, the standby position may be the position before the head case (210) enters the separation space (50) between the pair of sealing tools (10, 20), and the cleaning position may be the position that the head case (210) enters the separation space (50), whereby the upper opening (211) and the lower opening (212) are disposed approximately coaxially with the pair of sealing tools (10, 20) in the first axial direction (A1).

In addition, a head mirror part (260) is provided in the passage (215) of the head case (210). The head mirror part (260) is installed on the head case (210) to be rotatable at a predetermined angle. The head mirror part (260) performs a function of reflecting the carbon dioxide laser (L) entered along the second axial direction (A2) to the upper opening (211) or the lower opening (212) along the first axial direction (A1).

The head mirror part (260) may comprise a head mirror (261) and a head mirror driving part (262).

The head mirror (261) extends along the third axial direction (A3) and is disposed between the upper opening (211) and the lower opening (212). The head mirror (261) reflects the carbon dioxide laser (L) moving through the passage (215) into the first opening or the second opening. Depending on the rotation direction and angle of the head mirror (261), the reflection direction of the carbon dioxide laser (L) may vary. The head mirror (261) is provided to be rotatable in the forward direction or the backward direction (R1) within the head case (210).

The head mirror driving part (262) is coupled to the head mirror (261) to rotate the head mirror (261) at a predetermined angle, thereby being provided to adjust the reflection direction of the head mirror (261).

Referring to FIG. 9, upon cleaning the upper sealing tool (10), the head mirror driving part (262) adjusts the angle of the head mirror (261) so that the head mirror (261) is inclined upward toward the upper opening (211) at an angle of 135 degrees with respect to the second axial direction (A2). In this instance, the carbon dioxide laser (L) is reflected from the head mirror (261) in a first reflection direction (F1). The first reflection direction (F1) is a direction toward the upper opening (211) of the first axial direction (A1) in the second axial direction (A2).

The carbon dioxide laser (L) is reflected from the head mirror (261) in the first reflection direction (F1) to pass through the upper opening (211) in the first axial direction (A1), thereby being irradiated to the upper sealing tool (10). Then, the carbon dioxide laser (L) is continuously irradiated to the upper sealing tool (10) while being moved in the third axial direction (A3) by the lens position adjusting part (220).

Specifically, upon the cleaning mode of the pair of sealing tools (10, 20), the control part (700) may be provided so that the cleaning head part (200) is entered into the separation space between the pair of sealing tools (10, 20).

Also, upon cleaning the upper sealing tool (10) of the pair of sealing tools, the control part (700) may adjust the reflection direction of the head mirror part (260) to reflect the carbon dioxide laser (L) to the upper opening (211) facing the upper sealing tool (10). In addition, upon cleaning the upper sealing tool (10), the control part (700) is provided to move the lens (230) along the longitudinal direction (third axial direction) of the upper scaling tool (10) within the head case (210). In such a structure, upon cleaning the upper sealing tool (10), the carbon dioxide laser (L) is continuously irradiated along the longitudinal direction (third axial direction) of the upper sealing tool (10), thereby enabling continuous cleaning.

Referring to FIGS. 10 and 11, upon cleaning the lower sealing tool (20), the head mirror driving part (262) adjusts the angle of the head mirror (261) so that the head mirror (261) is inclined downward toward the lower opening (212) at an angle of 135 degrees with respect to the second axial direction (A2).

The carbon dioxide laser (L) is reflected from the head mirror (261) in a second reflection direction (F2). The second reflection direction (F2) is a direction toward the lower opening (212) of the first axial direction (A1) in the second axial direction (A2).

At this time, the carbon dioxide laser (L) is reflected from the head mirror (261) in the second reflection direction (F2) to pass through the lower opening (212) in the first axial direction (A1), thereby being irradiated to the lower sealing tool (20). Then, the carbon dioxide laser (L) is continuously irradiated to the lower sealing tool (20) while being moved in the third axial direction (A3) by the lens position adjusting part (220).

That is, when the cleaning of the upper sealing tool (10) is completed and the lower sealing tool (20) is cleaned, the carbon dioxide laser is continuously irradiated along the longitudinal direction of the lower sealing tool (20), thereby enabling continuous cleaning.

Specifically, upon cleaning the lower sealing tool (20), the control part (700) may adjust the reflection direction of the head mirror part (260) to reflect the carbon dioxide laser (L) to the lower opening (212) facing the lower sealing tool (20). That is, when the cleaning of the upper sealing tool (10) is completed, by adjusting the reflection direction of the head mirror from the upper opening side to the lower opening side, it is possible to perform the cleaning of the lower sealing tool (20).

Also, upon cleaning the lower sealing tool, the control part (700) may be provided to move the lens (230) along the longitudinal direction of the lower sealing tool (20) within the head case (210). In such a structure, when the cleaning of the upper sealing tool (10) is completed and the lower sealing tool (20) is cleaned, the carbon dioxide laser is continuously irradiated along the longitudinal direction of the lower sealing tool (20), thereby enabling continuous cleaning.

In addition, a lens (230) is coupled to the front end (the end facing the head mirror) of the lens position adjusting part (220). The lens (230) may be disposed to face the head mirror part (260) along the second axial direction (A2). A laser transmission part (300) may be coupled to the rear end of the lens position adjusting part (220).

Referring to FIG. 4, the lens position adjusting part (220) may be provided to be movable along the third axial direction (A3) within the head case (210).

The lens position adjusting part (220) adjusts the position of the lens (230) along the third axial direction (A3). By the lens position adjusting part (220), the position of the carbon dioxide laser (L) passing through the lens (230) is adjusted along the third axial direction (A3).

Referring to FIGS. 5 and 7, one or more smoke intake parts (270, 280) may be provided on the outer surface of the head case (210). The smoke intake parts (270, 280) perform a function of inhaling smoke generated while removing foreign substances (P) from the sealing tools (10, 20) by irradiating the sealing tools (10, 20) with the carbon dioxide laser (L). The smoke intake parts (270, 280) may be provided in a plurality of parts, and may be divided into a first smoke intake part (270) and a second smoke intake part (280), depending on the installation location.

Specifically, the first smoke intake part (270) may be provided on the upper surface of the head case (210) to be adjacent to the upper opening (211). The first smoke intake part (270) may be provided to inhale smoke generated while the carbon dioxide laser (L) removes foreign substances (P) of the upper sealing tool (10) of the pair of sealing tools.

In addition, the second smoke intake part (280) may be provided on the lower surface of the head case (210) to be adjacent to the lower opening (212). The second smoke intake part (280) may be provided to inhale smoke generated while the carbon dioxide laser (L) removes foreign substances (P) from the lower sealing tool of the pair of sealing tools.

Referring to FIGS. 3 to 8, the laser transmission part (300) connects the cleaning head part (200) and the laser generation part (400). The laser transmission part (300) transmits the carbon dioxide laser (L) emitted from the laser generation part (400) to the cleaning head part (200).

The laser transmission part (300) comprises a transmission pipe part (310) through which the carbon dioxide laser is transmitted, and at least one or more transmission mirror parts (360, 370) for adjusting the transmission direction of the carbon dioxide laser (L).

The transmission pipe part (310) connects the laser generation part (400) and the cleaning head part (200). The transmission pipe part (310) may be provided to block light transmission by subjecting to black anodizing with an aluminum material.

In addition, the transmission pipe part (310) may comprise a plurality of transmission pipes (320, 330) disposed sequentially along the traveling direction of the carbon dioxide laser, and at least one connection pipe part (340, 350) connecting the two transmission pipes adjacent to each other and disposed therein by the transmission mirror part (360, 370).

At least one transmission mirror part (360, 370) is disposed at a bent portion of the transmission pipe part (310), and adjusts the reflection direction of the carbon dioxide laser (L) so that the carbon dioxide laser (L) is transmitted from the laser generation part (400) to the cleaning head part (200).

The plurality of transmission mirror parts (360, 370) may comprise a first transmission mirror part (360) and a second transmission mirror part (370).

The first transmission mirror part (360) may comprise a first mirror member (361) and a first mirror driving part (362). The first mirror member (361) reflects the carbon dioxide laser (L). The first mirror driving part (362) may be provided so that it is coupled to the first mirror member (361) to adjust the angle of the first mirror member (361). The first mirror driving part (362) may comprise a motor.

In addition, the first transmission mirror part (360) is provided to reflect the traveling direction of the carbon dioxide laser (L) from the first axial direction (A1) to the second axial direction (A2). Referring to FIG. 8, the first transmission mirror part (360) may be installed at a bent portion of a first connection pipe (341) and a second bent portion (352) of a second connection pipe part (350), respectively.

The second transmission mirror part (370) may comprise a second mirror member (371) and a second mirror driving part (372). The second mirror member (371) reflects the carbon dioxide laser (L). The second mirror driving part (372) may be provided so that it is coupled to the second mirror member (371) to adjust the angle of the second mirror member (371). The second mirror driving part (372) may comprise a motor.

The second transmission mirror part (370) is provided to reflect the traveling direction of the carbon dioxide laser (L) from the second axial direction (A2) to the first axial direction (A1). Referring to FIG. 8, the second transmission mirror part (370) may be installed at a first bent portion (351) of a second connection pipe part (350) and a bent portion of a second connection pipe (342), respectively.

The transmission pipe part (310) comprises a plurality of transmission pipes (320, 330) and at least one connection pipe part (340, 350).

The plurality of transmission pipes (320, 330) may be disposed sequentially along the traveling direction of the carbon dioxide laser (L). Two transmission pipes (320, 330) adjacent to each other are connected by the connection pipe parts (340, 350). In this example, for convenience of explanation, the plurality of transmission pipes (320, 330) is referred to separately as a vertical transmission pipe (320) and a horizontal transmission pipe (330).

The vertical transmission pipe (320) is a pipe disposed in the first axial direction (A1). The vertical transmission pipe (320) guides the movement of the carbon dioxide laser (L) in the first axial direction (A1). In this example, the plurality of vertical transmission pipes (320) may be divided into a first vertical transmission pipe (321) and a second vertical transmission pipe (322) depending on the installation location. The first vertical transmission pipe (321) is coupled to the laser generation part (400). The second vertical transmission pipe (322) is coupled to the rear end of the lens position adjusting part (220).

The horizontal transmission pipe (330) is a pipe disposed in the second axial direction (A2). The horizontal transmission pipe (330) guides the movement of the carbon dioxide laser (L) in the second axial direction (A2). In this example, for convenience of explanation, the plurality of horizontal transmission pipes (330) is referred to separately as a first horizontal transmission pipe (331) and a second horizontal transmission pipe (332).

At least one connection pipe part (340, 350) is a pipe connecting two transmission pipes (320, 330) adjacent to each other. In this example, for convenience of explanation, the plurality of connection pipe parts (340, 350) is referred to separately as a first connection pipe part (340) and a second connection pipe part (350).

The first connection pipe part (340) connects the vertical transmission pipe (320) and the horizontal transmission pipe (330). The first connection pipe part (340) has an L-shaped bent structure. The first connection pipe part (340) may have one bent portion. The first transmission mirror part (360) or the second transmission mirror part (370) may be provided at the bent portion of the first connection pipe part (340).

Referring to FIG. 8, the plurality of first connection pipe parts (340) may be divided into a first connection pipe (341) and a second connection pipe (342) depending on the installation location. The first connection pipe (341) connects the first vertical transmission pipe (321) and the first horizontal transmission pipe (331). Also, the second connection pipe (342) connects the second vertical transmission pipe (322) and the second horizontal transmission pipe (332).

In addition, the first and second connection pipes (341, 342) may be provided so that based on one of two adjacent transmission pipes, the other transmission pipe is rotatably connected. In this way, the transmission pipe part (310) may have a joint structure based on the first and second connection pipes (341, 342), and accordingly, when the position of the lens (230) is moved along the third axial direction (A3) by the lens position adjusting part (220), the angle and distance between two adjacent transmission pipes in the transmission pipe part (310), and the like may change depending on the position of the lens (230) in the head case (210).

For example, one end (341a) of the first connection pipe (341) is connected to the first vertical transmission pipe (321), and the other end (341b) is connected to the first horizontal transmission pipe (331). At this time, one end (341a) of the first connection pipe (341) is rotatably connected in the forward direction or the backward direction (R2) with respect to the first vertical transmission pipe (321). That is, one end (341a) of the first connection pipe (341) is idle-rotatably connected with respect to the first vertical transmission pipe (321).

Also, one end (342a) of the second connection pipe (342) is connected to the second vertical transmission pipe (322), and the other end (342b) is connected to the second horizontal transmission pipe (332). At this time, one end (342a) of the second connection pipe (342) is rotatably connected in the forward direction or the backward direction (R4) with respect to the second vertical transmission pipe (322). That is, one end (342a) of the second connection pipe (342) is idle-rotatably connected with respect to the second vertical transmission pipe (322).

In addition, the second connection pipe part (350) connects the first horizontal transmission pipe (331) and the second horizontal transmission pipe (332). The second connection pipe part (350) has an S-shaped bent structure. The second connection pipe part (350) has two bent portions.

The second connection pipe part (350) has a first bent portion (351) connected to the first horizontal transmission pipe (331) and a second bent portion (352) connected to the second horizontal transmission pipe (332). The second transmission mirror part (370) is installed at the first bent portion (351). The first transmission mirror part (360) is installed at the second bent portion (352). At this time, the second bent portion (352) is rotatably connected in the forward direction or the backward direction (R3) with respect to the first bent portion (351). That is, the second bent portion (352) is idle-rotatably connected with respect to the first bent portion (351).

The carbon dioxide laser (L) is incident to the second transmission mirror part (370) installed at the first bent portion (351) along the second axial direction (A2) in the first horizontal transmission pipe (331), and is reflected from the second transmission mirror part (370) to move toward the second bent portion (352) in the first axial direction (A1). Subsequently, the carbon dioxide laser (L) is reflected in the second axial direction (A2) from the first transmission mirror part (360) installed at the second bent portion (352) to move to the second horizontal transmission pipe (332). In addition, the carbon dioxide laser passing through the second vertical transmission pipe (322) is transmitted to the lens (230).

Referring to FIG. 12, the laser generation part (400) may comprise a generation chamber (410), a pair of electrode plates (420), and a resonance part (430). The laser generation part (400) generates a carbon dioxide laser (L) and emits it to the laser transmission par (300). The carbon dioxide laser (L) is a laser using carbon dioxide gas as a medium.

The generation chamber (410) may be coupled to the main body part (600). Then, the generation chamber (410) is coupled to the first vertical transmission pipe (321) of the laser transmission part (300).

In the generation chamber (410), the carbon dioxide gas is sealed in the internal space., The pair of electrode plates (420) are installed on the inner surface of the generation chamber (410) to face each other. Then, an output mirror (450) and a total reflection mirror (440) are installed on the inner surface of the generation chamber (410) to face each other in a direction perpendicular to the arrangement direction of the electrode plates.

The pair of electrode plates (420) is electrically connected to an external power source (460). When electric power is applied to the electrode plates (420), plasma is generated in the carbon dioxide gas while a discharge occurs between the pair of electrode plates (420), whereby carbon dioxide molecules are changed into an excited state. When the number of carbon dioxide molecules in the excited state increases, it becomes a stimulated emission state. In FIG. 12, a symbol C1 represents the ground state, C2 represents the excited state, and C3 represents the stimulated emission state.

The resonance part (430) may comprise the total reflection mirror (440) and the output mirror (450). The resonance part (430) may amplify the carbon dioxide gas in the excited state to emit it to the output mirror (450) as the carbon dioxide laser (L), while reciprocating light between the total reflection mirror (440) and the output mirror (450). The carbon dioxide laser (L) emitted from the output mirror (450) is transmitted to the cleaning head part (200) through the laser transmission part (300).

The laser generation part (400) may adjust the output energy of the carbon dioxide laser (L) according to the control signal from the control part (700).

The laser generation part (400) may be provided to output the carbon dioxide laser (L) within a range of 30W to 200W. In addition, the laser generation part (400) may output the carbon dioxide laser (L) within the range of 80W to 120W. For example, the carbon dioxide laser (L) may be irradiated to the upper sealing tool (10) and/or the lower sealing tool (20) with an output of 100W to remove the foreign substances (P) present in the upper sealing tool (10) and/or the lower sealing tool (20).

The carbon dioxide laser (L) may have a wavelength larger than the wavelength of a fiber laser. The fiber laser has a wavelength of approximately 1 μm. On the other hand, the carbon dioxide laser (L) may have a wavelength ranging from 9 μm to 12 μm. As one example, the carbon dioxide laser (L) may have a wavelength of 10.6 μm.

Because the carbon dioxide laser (L) has a wavelength range approximately 10 times larger than that of the fiber laser, it is difficult to transmit the laser using an optical fiber. Accordingly, the present invention can transmit the carbon dioxide laser (L) by providing the laser transmission part (300) as described above with at least one transmission mirror part (360, 370).

The carbon dioxide laser (L) has metal absorption and metal reflection rates lower than those of the fiber laser. It can be known that the carbon dioxide laser (L) has the reflection and absorption rates for copper (Cu) close to 0%. That is, it can be known that the carbon dioxide laser (L) hardly reacts with copper (Cu), which is a material of the sealing tools (10, 20).

On the other hand, it can be known that the fiber laser has reflection and absorption rates for steel of approximately 40%, and reflection and absorption rates for copper (Cu) of approximately 10%. That is, it can be known that the fiber laser reacts with all metals. Accordingly, when the foreign substances (P) of the sealing tools (10, 20) are removed using the fiber laser, a problem of damaging the sealing tools (10, 20) is caused in the process of removing the foreign substances (P).

Referring to FIG. 9, the carbon dioxide laser (L) emitted from the laser generation part (400) enters the first vertical transmission pipe (321) in the first axial direction (A1). The carbon dioxide laser (L) moving the first vertical transmission pipe (321) is reflected from the first axial direction (A1) to the second axial direction (A2) by the first transmission mirror part (360) installed in the first connection pipe (341), and transmitted to the first horizontal transmission pipe (331).

The carbon dioxide laser (L) moving the first horizontal transmission pipe (331) is reflected from the second axial direction (A2) to the first axial direction (A1) by the second transmission mirror part (370) installed at the first bent portion (351) of the second connection pipe part (350), and transmitted to the first transmission mirror part (360) installed at the second bent portion (352) of the second connection pipe part (350).

Subsequently, the carbon dioxide laser (L) is reflected from the first axial direction (A1) to the second axial direction (A2) by the first transmission mirror part (360) at the second bent portion (352), and transmitted to the second horizontal transmission pipe (332).

The carbon dioxide laser (L) moving the second horizontal transmission pipe (332) is reflected from the second axial direction (A2) to the first axial direction (A1) by the second transmission mirror part (370) installed at the bent portion of the second connection pipe (342), and transmitted to the second vertical transmission pipe (322).

The carbon dioxide laser (L) moving the second vertical transmission pipe (322) is reflected from the first axial direction (A1) to the second axial direction (A2) by the first transmission mirror part (360) installed in the lens position adjusting part (220), and transmitted to the lens (230). The carbon dioxide laser (L) passing through the lens (230) moves to the head mirror (261) via the passage (215) along the second axial direction (A2).

Referring to FIG. 9, upon cleaning the upper sealing tool (10), the head mirror (261) is disposed to be inclined upward toward the upper opening (211). The carbon dioxide laser (L) is reflected from the head mirror (261) to the first reflection direction (F1) to pass through the upper opening (211) along the first axial direction (A1), and irradiated to the upper sealing tool (10). Accordingly, as the lens position adjusting part (220) moves the lens in the third axial direction (A3), the upper sealing tool (10) is continuously cleaned along the third axial direction (A3).

Referring to FIGS. 10 and 11, upon cleaning the lower sealing tool (20), the head mirror (261) is disposed to be inclined downward toward the lower opening (212). The carbon dioxide laser (L) passing through the lens (230) moves to the head mirror (261) via the passage (215) in the second axial direction (A2). The carbon dioxide laser (L) is reflected from the head mirror (261) to the second reflection direction (F2) to pass through the lower opening (212) along the first axial direction (A1), and irradiated to the lower sealing tool (20). Accordingly, while the lens position adjusting part (220) moves the lens in the third axial direction (A3), the lower sealing tool (20) is continuously cleaned along the third axial direction (A3).

The present invention can remove the foreign substances (P) from the upper sealing tool (10), and then continuously remove the foreign substances (P) from the lower sealing tool (20), by adjusting the reflection direction of the carbon dioxide laser (L) through the angle adjustment of the head mirror (261), thereby improving the cleaning efficiency of the sealing tools (10, 20).

As in the present invention, the sealing tools (10, 20) from which foreign substances (P) have been cleaned provide uniform pressure to the pouch case, whereby compared to the case of sealing the pouch case with the sealing tools having foreign substances present, it is possible to seal the pouch case in a relatively thin thickness.

The sealing tool cleaning method according to one example of the present invention is a sealing tool cleaning method using the sealing tool cleaning device, which may comprise a step (a) of mounting mask jigs on the pair of sealing tools, respectively, a step (b) of entering the cleaning head part into the separation space between the pair of sealing tools, and a step (c) of adjusting the head mirror part to reflect the carbon dioxide laser toward the first opening or the second opening of the head case.

In addition, the sealing tool cleaning method may comprise a step of adjusting the reflection direction of the head mirror part to reflect the carbon dioxide laser toward the first opening upon cleaning the upper sealing tool of the pair of sealing tools, and operating the lens position adjusting part to move the lens along the longitudinal direction of the upper sealing tool, and a step of adjusting the reflection direction of the head mirror part to reflect the carbon dioxide laser toward the second opening upon cleaning the lower sealing tool of the pair of sealing tools, and operating the lens position adjusting part to move the lens along the longitudinal direction of the lower sealing tool.

The preferred examples of the present invention as described above have been disclosed for illustrative purposes, and those skilled in the art having ordinary knowledge of the present invention will be able to make various modifications, changes, and additions within the spirit and scope of the present invention, and such modifications, changes, and additions should be regarded as falling within the scope of the following claims.

### INDUSTRIAL APPLICABILITY

According to the sealing tool cleaning device related to at least one example of the present invention, and the sealing tool cleaning method using the same, by using a carbon dioxide laser, it is possible to remove only foreign substances present in the sealing tools, and by removing foreign substances from the sealing tools in a non-contact manner, it is possible to prevent damage to the sealing tools.

1. A sealing tool cleaning device for cleaning a pair of sealing tools sealing a pouch case, comprising:
a laser generation part configured for generating a carbon dioxide laser;
a cleaning head part configured to enter a separation space between the pair of sealing tools, and including a head case having first and second openings opened toward the pair of sealing tools, respectively, and a head mirror part rotatably installed within the head case and configured to reflect the carbon dioxide laser toward the first opening or the second opening; and
a laser transmission part configured to transmit the carbon dioxide laser generated by the laser generation part to the cleaning head part.

2. The sealing tool cleaning device according to claim 1, wherein
the cleaning head part is connected to the laser transmission part, and comprises a lens for transmitting the carbon dioxide laser transmitted from the laser transmission part to the head mirror part, and a lens position adjusting part configured to adjust the position of the lens within the head case.

3. The sealing tool cleaning device according to claim 2, wherein
the first and second openings extend along the longitudinal direction of the facing sealing tools, respectively, and
the lens position adjusting part is configured to move the lens along a longitudinal direction of the sealing tools within the head case.

4. The sealing tool cleaning device according to claim 1, wherein
the laser transmission part comprises a transmission pipe part through which the carbon dioxide laser is transmitted, and one or more transmission mirror parts for adjusting the transmission direction of the carbon dioxide laser within the transmission pipe part.

5. The sealing tool cleaning device according to claim 4, wherein the transmission pipe part comprises:
a plurality of transmission pipes disposed sequentially along a traveling direction of the carbon dioxide laser; and
at least one connection pipe part connecting two adjacent ones of the plurality of transmission pipes, and having the transmission mirror part disposed therein.

6. The sealing tool cleaning device according to claim 5, wherein
the at least one connection pipe part is configured so that based on one of the two adjacent transmission pipes, the other transmission pipe is rotatably connected.

7. The sealing tool cleaning device according to claim 2, further comprising
a head position adjusting part coupled to the cleaning head part and configured for adjusting a position of the head case so that the cleaning head part enters the separation space between the pair of sealing tools.

8. The sealing tool cleaning device according to claim 7, further comprising
a control part for controlling the laser generation part and the cleaning head part, wherein
the control part is provided configured to enter the cleaning head part into the separation space between the pair of sealing tools upon a cleaning mode of the pair of sealing tools.

9. The sealing tool cleaning device according to claim 8, wherein
for cleaning an upper sealing tool of the pair of sealing tools, the control part is configured to adjust the reflection direction of the head mirror part to reflect the carbon dioxide laser to the first opening facing the upper sealing tool, and for cleaning a lower sealing tool, the control part is configured to adjust the reflection direction of the head mirror part to reflect the carbon dioxide laser to the second opening facing the head mirror.

10. The sealing tool cleaning device according to claim 9, wherein
the control part is configured to move the lens along the longitudinal direction of the upper sealing tool within the head case for cleaning the upper sealing tool, and is configured to move the lens along the longitudinal direction of the lower sealing tool within the head case for cleaning the lower sealing tool.

11. The sealing tool cleaning device according to claim 10, wherein
when the head case is positioned in the separation space between the pair of sealing tools for cleaning the upper sealing tool, the control part is configured to adjust the reflection direction of the head mirror part so that the head mirror part reflects the carbon dioxide laser toward the first opening, and to operate the lens position adjusting part to move the lens along the longitudinal direction of the upper sealing tool.

12. The sealing tool cleaning device according to claim 10, wherein
when the head case is positioned in the separation space between the pair of sealing tools for cleaning the lower sealing tool, the control part is configured to adjust the reflection direction of the head mirror part so that the head mirror part reflects the carbon dioxide laser toward the second opening, and to operate the lens position adjusting part to move the lens along the longitudinal direction of the lower sealing tool.

13. The sealing tool cleaning device according to claim 1, wherein the head mirror part comprises:
a head mirror disposed between the first and second openings and extending along the longitudinal direction of the sealing tool; and
a head mirror driving part rotating the head mirror at a predetermined angle to adjust the reflection direction of the head mirror.

14. A sealing tool cleaning method using the sealing tool cleaning device according to claim 1 comprises steps of:
mounting mask jigs on the pair of sealing tools, respectively;
entering the cleaning head part into the separation space between the pair of sealing tools; and
adjusting the head mirror part to reflect the carbon dioxide laser toward the first opening or the second opening of the head case.

15. The sealing tool cleaning method according to claim 14, wherein
the cleaning head part is connected to the laser transmission part, and comprises a lens for transmitting the carbon dioxide laser transmitted from the laser transmission part to the head mirror part, and a lens position adjusting part provided to adjust the position of the lens within the head case, and
the sealing tool cleaning method comprises a step of adjusting the reflection direction of the head mirror part to reflect the carbon dioxide laser toward the first opening for cleaning the upper sealing tool of the pair of sealing tools, and operating the lens position adjusting part to move the lens along the longitudinal direction of the upper sealing tool, and
a step of adjusting the reflection direction of the head mirror part to reflect the carbon dioxide laser toward the second opening for cleaning the lower sealing tool of the pair of sealing tools, and operating the lens position adjusting part to move the lens along the longitudinal direction of the lower scaling tool.
